(19) United States
(12) Patent Application Publication
(10) Pub. No.: US 2008/0242129 A1
(43) Pub. Date: Oct. 2, 2008

(54) Universal two-hole electrical bond washer

(76) Inventors: Matthew Robert Younce, Marysville, CA (US); Timothy Sheldon Springsteen, Brownsville, CA (US)

Correspondence Address: JAMES GORDON CRUMMETT, 7168 WHITE OAK LANE, BROWNS VALLEY, CA, 95918, US

(21) Appl. No.: 12/077,523

(22) Filed: Mar. 20, 2008

Related U.S. Application Data
(60) Provisional application No. 60/920,131, filed on Mar. 27, 2007.

(51) Int. Cl. H01R 4/66

(52) U.S. Cl. 439/100; 439/108; 439/801

(57) ABSTRACT

The INVENTION is a single, two-hole, electrical bond washer which replaces individual single-hole flat washers that are used in the process of bonding electrical wire lugs to ground bars for protection against lightning.

This Application claims priority from the PROVISIONAL APPLICATION Ser. No. 60/920,131 which was filed Mar. 27, 2007.

### SPECIFICATION

### BACKGROUND OF THE INVENTION

For electrical equipment, it is often required that an electrically conductive path to ground (earth) be provided in order that lightning will not damage the equipment. In many industries, such as telecommunications, aviation, solar and others, the method of providing this connection to ground involves the routing of ground wires to some common metal ground bar with subsequent connection to earth. This ground bar has many holes in it to which electrical wire lugs are fastened by using an assortment of bolts, nuts, and flat washers. Since there are two holes in the wire lug which mate up with two holes in the ground bar, two sets of bolts, nuts and flat washers are required for each connection. When the nuts are tightened to their rated torque, a clamping force acts through the flat washer, through the wire lug, and onto the ground bar. This clamping action between the wire lug and ground bar assures a secure and low resistance electrical connection between the wire lug and the ground bar. If the clamping action is not uniform throughout the mating surfaces of the wire lug and the ground bar, less than optimum electrical contact will result. The action of electrically connecting multiple grounding wires to a single point and then to earth is referred to as “bonding”. This assures that all the wires are of the same voltage potential. Hopefully, the electrical connection also has the lowest resistance that can be achieved.

When installed on a two-hole wire lug, two individual flat washers will have a gap between their respective outer diameters due to bolt spacing. Consequently, there will be an uneven clamping force and, therefore, uneven surface contact between the wire lug and the ground bar. Additionally, there is an interference fit between the outer diameters of adjacent single-hole flat washers when installed on side-by-side wire lugs. Installers are forced either to cut off the sides of the flat washers so that wire lugs can be placed side-by-side, or they must install the wire lugs in alternating hole-pairs. This is a waste of ground bar real estate.

### BRIEF SUMMARY OF THE INVENTION

Instead of a single-hole flat washer, the INVENTION is a two-hole electrical bond washer with universal application for many industries. This is a true innovation. The placement of one electrical bond washer per connection to the ground bar instead of the usual two flat washers reduces the number of pieces an installer must handle, and lessens the time to complete an installation. This is a useful benefit of the INVENTION. More importantly, the novel two-hole electrical bond washer consists of a single, stiff piece, allowing a uniform clamping force across the entire mating surface between the wire lug and the ground bar. This results in a connection (between the wire lug and the ground bar) with greater current-carrying capacity than that which can be achieved with individual single-hole washers. Not only is this INVENTION useful in that it reduces the number of parts an installer must handle, but also the INVENTION makes possible a very desirable increase in electrical integrity between a wire lug and a ground bar. This INVENTION provides a significant functional improvement over present technology and methodology.

### DETAILED DESCRIPTION OF THE INVENTION

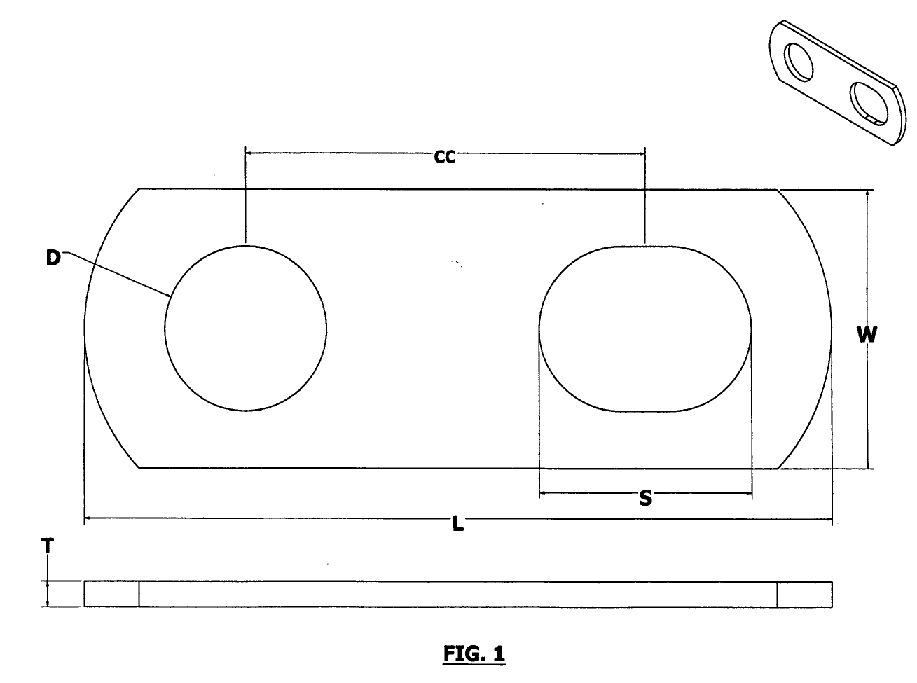

Referring to the drawing in FIG. 1, a typical universal two-hole electrical bond washer is depicted. Different production models have different dimensions; the dimensional variations are manufactured to suit the customer's specifications. The width W of the part will be manufactured to match the width of the wire lug; the length L will be matched to the length of the wire lug; the center-to-center hole spacing CC is made to match the spacing of the holes in the wire lug as well as in the ground bar; diameter D will be made suitable to the size of the bolts used in the installation; slot length S allows for tolerances and some hole spacing variations in the ground bar and wire lugs; thickness T will vary according to demands placed upon the material of the electrical bond washer by the clamping force which results from the proper torque values for the size of bolt used.

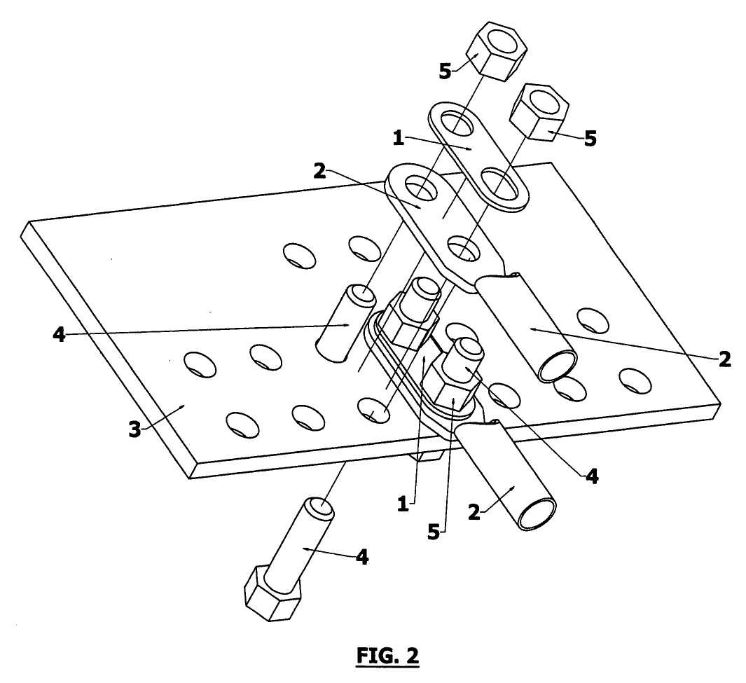

Referring to the drawing in FIG. 2, the INVENTION, as it is used in a typical electrical bonding application, is shown with a portion in exploded detail for clarity. The bond washer I is clamped against wire lug 2 by the nut 5 on the bolt 4. As a result, wire lug 2 is clamped uniformly against the surface of the ground bar 3, creating an improved electrical contact.

1. A two-hole electrical bond washer that is substituted for single-hole flat washers in order to achieve electrical bonding for lightning protection. The stiffness of the INVENTION is such that it assures even distribution of the clamping forces being applied between a wire lug and a ground bar. Said evenly distributed clamping forces result in an area of uniform electrical contact between a wire lug and a ground bar. Said area of uniform electrical contact minimizes the electrical resistance between the two mating surfaces, thereby increasing the current-carrying capacity of the junction, and also providing a gas-tight seal. The features of the INVENTION satisfy the spatial, physical, and electrical requirements of the ground bars and wire lugs that constitute standard electrical components used for electrical bonding in various industries. The INVENTION is of sufficient yield strength such that it will not shear or extrude under normal clamping forces. The INVENTION is considered to have universal usefulness in electrical bonding applications in that it can be manufactured with various dimensional changes to accommodate different sized wire lugs and ground bars without changing the fundamental nature and sole purpose of the INVENTION.

2. An electrical bond washer of claim 1, wherein the material used is a metal such as, but not limited to, 301 ¼-hard stainless steel. The electrical bond washers can be produced by a punch press.

3. An electrical bond washer of claim 1, wherein the material used is a non-conductive material such as, but not limited to, glass-filled nylon. The electrical bond washer can be produced by an injection molding process.

4. An electrical bond washer of claims 2 and 3, wherein the design and manufacture of the INVENTION can include two holes of identical size up to 1-inch diameter; or two holes of differing sizes up to 1-inch diameter each; or one hole of any size up to 1-inch diameter and a slot of any size up to 1-inch wide by up to 2-inches long; or two slots of any differing sizes with widths and lengths up to 2-inches in either dimension. Said features will be spaced apart by a distance up to 4-inches center-to-center. The length of the INVENTION will be up to 6-inches long; the width will be up to 2-inches wide, and the thickness will be up to ⅜-inch thick; all dimensions will be manufactured to sizes as required by the application within which the INVENTION will be used.
